(19) United States
(12) Patent Application Publication
(10) Pub. No.: US 2010/0008743 A1
(43) Pub. Date: Jan. 14, 2010

(54) Device for Inhibiting Unfastening Rotation of Rotary Fasteners, Particularly for Vehicle Wheels

(76) Inventor: Gregory James Bawden, Mount Hope (CA)

Correspondence Address: James David Johnson, P.A., 401 East Las Olas Boulevard, Suite 130-290, Fort Lauderdale, FL, 33301, US

(21) Appl. No.: 12/498,801

(22) Filed: Jul. 7, 2009

Related U.S. Application Data
(60) Provisional application No. 61/129,627, filed on Jul. 8, 2008.

(51) Int. Cl. F16B 39/10

(52) U.S. Cl. 411/130

(57) ABSTRACT

There is a significant problem associated with the rotary fasteners (such as bolts and nuts) used to secure wheels to vehicles becoming unfastened and resulting in separation of the wheel from the vehicle. Devices are provided for inhibiting unfastening rotation of rotary fasteners on vehicle wheels, with the devices comprising a housing that is securable over an exterior face of a vehicle wheel having a plurality of rotary fasteners, with a plurality of receivers secured within the housing and adapted to non-rotatably receive the rotary fasteners. The devices are configured so that the receivers can be rotated relative to the housing in at least one direction during securing of the housing over the exterior face of the vehicle wheel, and can be inhibited from rotating in an unfastening direction once the housing is secured over the exterior face of the vehicle wheel.

### CROSS-REFERENCE TO RELATED APPLICATION

This application claims priority to U.S. Provisional Application No. 61/129,627 filed on Jul. 8, 2008, the teachings of which are hereby incorporated by reference in their entirety.

### FIELD OF INVENTION

The present invention relates to road vehicles, and more particularly to a device for inhibiting undesirable rotation of rotary fasteners used to secure wheels on road vehicles.

### BACKGROUND OF THE INVENTION

Road vehicles, and in particular trucks, transport enormous quantities of goods. These trucks have wheels that are secured to their axles by rotary fasteners, typically a nut or bolt or both. For example, a wheel may have a plurality of apertures corresponding in position to threaded bores on the end of the axle to which the wheel is to be attached, and threaded bolts may be passed through the apertures in the wheel and threaded into the threaded bores on the axles, so as to secure the wheel to the axle. Alternatively, an end of an axle may have apertures shaped to receive a bolt, and a truck wheel may have correspondingly positioned apertures through which the threaded shafts of the bolts may pass. A nut can then be threaded onto the threaded shaft of the bolt from the outside of the wheel, so as to secure the wheel to the axle.

Unfortunately, a problem has arisen in that the vibration associated with the travel of heavy vehicles, such as trucks, buses and the like, has a tendency to loosen the rotary fasteners. In some cases, particularly where the rotary fasteners are not routinely inspected and tightened, the loosening can eventually result in complete unfastening of the rotary fasteners, which can result in catastrophic separation of the wheel from the axle. When such wheel separation occurs at high speed (e.g. on a freeway), the separated wheel may collide with other vehicles, causing death or injury.

### SUMMARY OF THE INVENTION

In one aspect, the present invention is directed to a device for inhibiting unfastening rotation of rotary fasteners on a vehicle wheel. The device comprises a housing that is removably securable over an exterior face of a vehicle wheel, and a plurality of receivers. The receivers are arranged in the housing so as to be complementary to positions of the rotary fasteners on the vehicle wheel over which the housing is to be secured. The receivers each have an aperture defined therein to non-rotatably receive at least a portion of a rotary fastener. The device includes a rotation control mechanism disposed within the housing operable to inhibit rotation of the receivers relative to the housing in an unfastening direction and permit rotation of the receivers in a fastening direction, with both the fastening and the unfastening directions being relative to the rotary fasteners.

In one embodiment, each receiver has a toothed inner peripheral rim.

In one embodiment, each receiver has a toothed outer peripheral rim, and the rotation control mechanism comprises a plurality of individual ratchet arrangements. Each ratchet arrangement comprises a pawl adapted to engage the toothed outer peripheral rim and a biasing member operable to bias the pawl into engagement with the toothed outer peripheral rim, so that rotation of the receivers in an unfastening direction is resisted by engagement of teeth on the toothed outer peripheral rim with the pawl, and rotation of the receivers in a fastening direction is permitted.

In one embodiment, each pawl is pivotally mounted to the housing.

In a particular embodiment, the rotation control mechanism may further comprise a plurality of disengagement actuators, with each disengagement actuator corresponding to one of the ratchet arrangements. Each disengagement actuator is selectively operable to move its respective pawl out of engagement with the toothed outer peripheral rim of the respective receiver to enable free rotation of the receiver relative to the housing.

In another aspect, the present invention is directed to a device for inhibiting unfastening rotation of rotary fasteners on a vehicle wheel. The device comprises a housing that is removably securable over an exterior face of a vehicle wheel. A plurality of receivers are arranged in the housing so as to be complementary to positions of rotary fasteners on the vehicle wheel over which the device is to be secured. The receivers each have an aperture defined therein to non-rotatably receive at least a portion of a rotary fastener. The device includes a mechanism that is selectively movable between a first configuration in which rotation of the receivers relative to the housing is resisted, and a second configuration in which rotation of the receivers relative to the housing is permitted, and the mechanism is securable in at least the first configuration.

In still another aspect, the present invention is directed to a device for inhibiting unfastening rotation of rotary fasteners on a vehicle wheel. The device comprises a housing adapted to be removably secured over an exterior face of a vehicle wheel having a plurality of rotary fasteners. A plurality of receivers are secured within the housing and adapted to non-rotatably receive at least a portion of each of the rotary fasteners on the vehicle wheel. The receivers can be rotated relative to the housing in at least one direction during securing of the housing over the exterior face of the vehicle wheel, and can be inhibited from rotating in an unfastening direction once the device is secured over the exterior face of the vehicle wheel.

### BRIEF DESCRIPTION OF THE DRAWINGS

These and other features of the invention will become more apparent from the following description in which reference is made to the appended drawings wherein:

FIG. 1 shows a front view of an exemplary embodiment of a device according to an aspect of the present invention;

FIG. 1A shows a front view of an exemplary vehicle wheel in accordance with which a device according to an aspect of the present invention may be used;

FIG. 2 shows a side cut-away view of a portion of the device of FIG. 1;

FIG. 3 shows a front cut-away view of a portion of the device of FIG. 1;

FIG. 4 shows a front view of an exemplary ratchet arrangement, in accordance with a particular embodiment of an aspect of the present invention; and

FIG. 5 shows a cut-away view of a portion of an exemplary embodiment of a mechanism for selectively resisting and permitting rotation of a receiver, according to an aspect of the present invention.

FIG. 6 is an exterior front view of the portion of the exemplary embodiment shown in FIG. 5;

FIG. 7 shows a rear view of the device of FIG. 1;

FIG. 8 shows a side cut-away view of a portion of the device of FIG. 1, with a crown nut and pin arrangement being used to retain the device on a vehicle wheel, according to an aspect of the present invention;

FIG. 9 shows a side cut-away view of a portion of the device of FIG. 1, with a nut, securing panel and pin arrangement being used to retain the device on a vehicle wheel, according to an aspect of the present invention;

FIG. 10 shows a plan view of a securing panel according to an aspect of the present invention.

### DETAILED DESCRIPTION

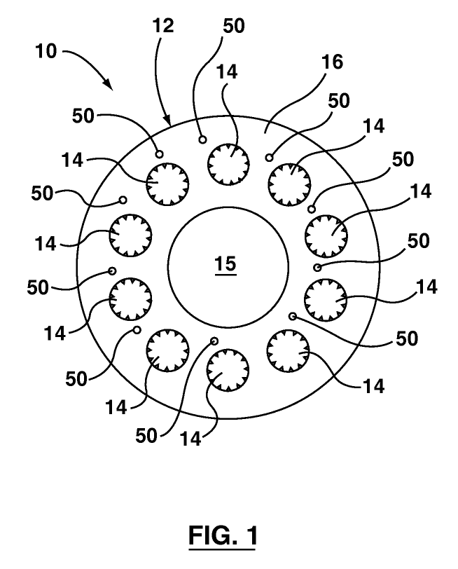

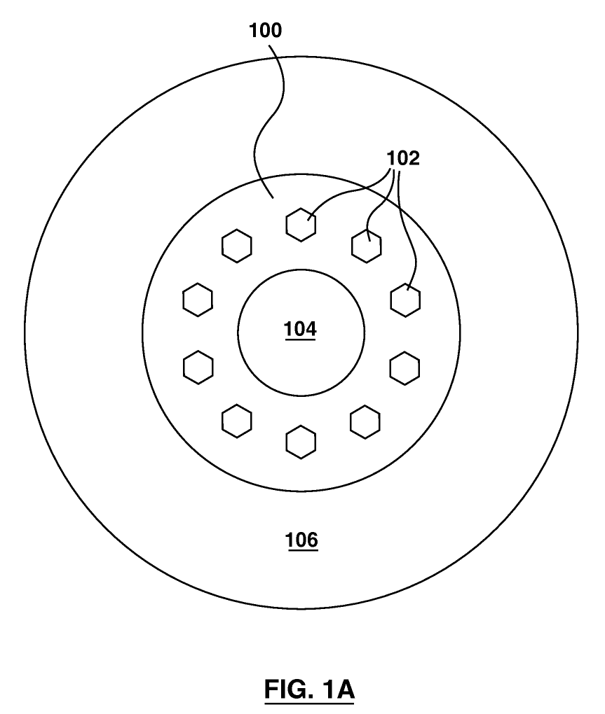

An exemplary vehicle wheel is shown in FIG. 1A, and is denoted generally by the reference numeral 100. The vehicle wheel 100 is secured to an axle (not shown) by a plurality of bolts 102 disposed in a circular arrangement about a rim hub 104. A tire 106 is mounted to the wheel as is conventionally known.

With reference now to FIG. 1, an exemplary embodiment of a device for inhibiting unfastening rotation of rotary fasteners on a vehicle wheel is shown generally at 10. The device 10 comprises a housing 12, with a plurality of receivers 14 being rotatably mounted within the housing 12. The housing 12 is removably securable over a vehicle wheel (not shown in FIG. 1). The receivers 14 each have a central aperture and are adapted to non-rotatably receive within the central aperture at least a portion of a rotary fastener on the vehicle wheel, so that the rotary fastener cannot rotate relative to the receiver 14. The receivers 14 are mounted in the housing 12 so as to be rotatable relative thereto, subject to operation of a rotation control mechanism, which is operable to inhibit rotation of the receivers in an unfastening direction and permit rotation of the receivers in a fastening direction, as will be described in greater detail below.

As used herein, the term “rotary fastener” includes any fastener that is secured by way of threading and rotation to move the fastener along the thread, including but not limited to nuts, bolts, and the like. As used herein, in respect of a particular rotary fastener, and hence in respect of a receiver that receives that rotary fastener, the term “unfastening direction” refers to the direction of rotation that would loosen or (further) unfasten that rotary fastener, and the term “fastening direction” refers to the direction of rotation that would tighten or (further) fasten that rotary fastener.

A device according to an aspect of the present invention maybe mounted over the outside of a vehicle wheel so that the rotary fasteners on the vehicle wheel are received in the receivers, to inhibit unfastening of the rotary fasteners due to vibration (since rotation in the unfastening direction is resisted). In addition, enabling rotation of the receivers in the fastening direction facilitates mounting of the device over the vehicle wheel, since the receivers can be individually rotated in the fastening direction during installation so as to align the receivers with the particular individual rotational positions of the rotary fasteners.

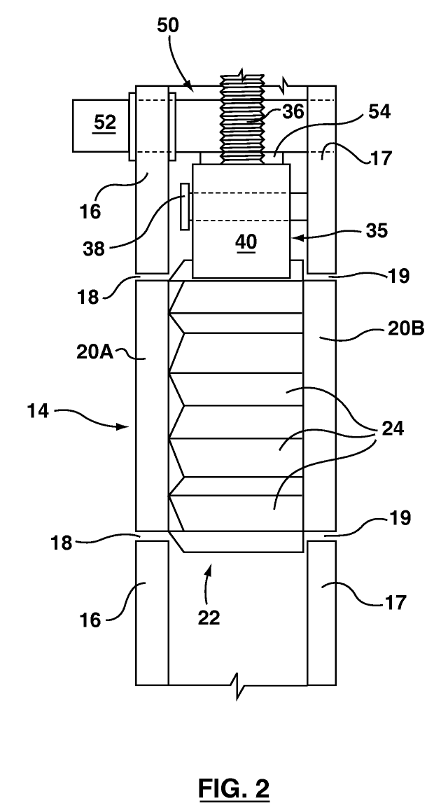

Continuing to refer to FIG. 1, in an exemplary embodiment the housing 12 is formed from two plates 16, 17 (see FIG. 2), typically circular as shown in the figures, secured in spaced, parallel relationship to one another, for example by way of a plurality of posts of equal length welded between the two plates. Only the outer plate 16 (i.e. the plate that will face outward relative to a vehicle wheel over which the housing will be secured) is visible in FIG. 1. The housing 12 defines an inner aperture or bore 15, which is provided to enable the housing 12 to clear the rim hub of a vehicle wheel over which the housing 12 is to be mounted. Optionally, an annular ring may be provided around the inner and outer circumferences of the housing 12, so as to assist in protecting the rotation control mechanism disposed between the two plates 16, 17. Such annular rings may also serve to space the plates 16, 17 from one another. The rotation control mechanism will be described in greater detail below. Typically, the plates 16, 17 and annular rings will be made from steel, although other suitable materials may also be used. For example, suitable aluminum or other alloys may provide for a desirable reduction in the weight of the housing 12.

With reference now to FIG. 2, in one embodiment, the outer plate 16 and inner plate 17 each have a plurality of respective spaced apart, opposed circular apertures 18, 19 defined therein, and the receivers 14 have outer and inner truncated shaft portions 20A, 20B, respectively, which are received within the respective circular apertures 18, 19 so that the receivers 14 are freely rotatable relative to the housing 12. The fit between the opposed circular apertures 18, 19 and the outer and inner truncated shaft portions 20A, 20B, respectively, should be sufficiently close to inhibit shaking and rattling of the receivers 14, while still permitting free rotation of the receivers 14.

In a preferred embodiment, each receiver 14 has a toothed outer peripheral rim 22 comprising a plurality of teeth 24, and the toothed outer peripheral rim 22 has an outer circumference greater than the circumference of the spaced apart, opposed circular apertures 18, 19 defined in the outer plate 16 and inner plate 17. Accordingly, the toothed outer peripheral rim 22 serves to retain the receiver 14 within the housing 12. Optionally (not shown), bushing and/or bearing arrangements may be provided to facilitate retention of the receivers 14 within, and rotation of the receivers 14 relative to, the housing 12. Such arrangements will be apparent to one skilled in the art, once informed by the herein disclosure. Thus, the receivers 14 maybe rotatably mounted in the housing 12 by any suitable technique.

As noted above, the housing 12 is removably securable over an exterior face of a vehicle wheel, such as the vehicle wheel shown in FIG. 1A. The housing 12 maybe mounted directly to a vehicle wheel, for example by way of clamping, magnetic attachment or other suitable removable attachment.

Referring again to FIG. 1, the receivers 14 are arranged in the housing so as to be complementary to positions of rotary fasteners (not shown in FIG. 1, see FIG. IA) on the vehicle wheel over which the device 10 is to be mounted. It will be appreciated that the size of the housing 12 and the spacing and arrangement of the receivers 14 will depend on the size of the vehicle wheel over which the device 10 is to be mounted, along with the particular arrangement of rotary fasteners on that vehicle wheel. Thus, it is contemplated that there will be various different embodiments of devices according to aspects of the present invention, with each such embodiment being designed for mounting over a particular type of vehicle wheel. Generally, the outer circumference of the housing 12 will be larger than the circumference of the circle formed by the arrangement of rotary fasteners on the vehicle wheel, and the inner aperture 15 will have a diameter sufficient to enable the housing 12 to clear the wheel hub.

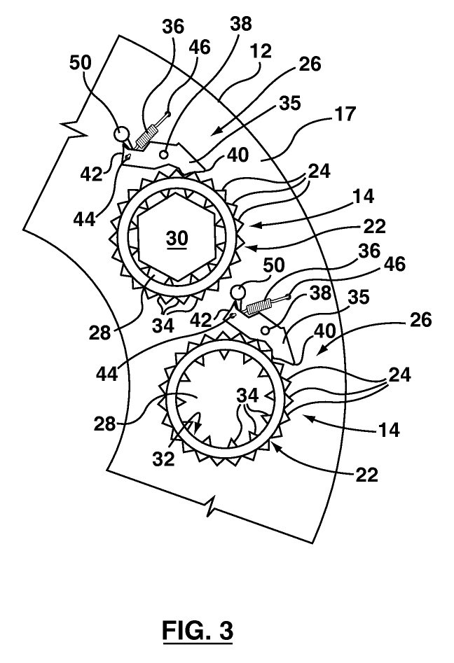

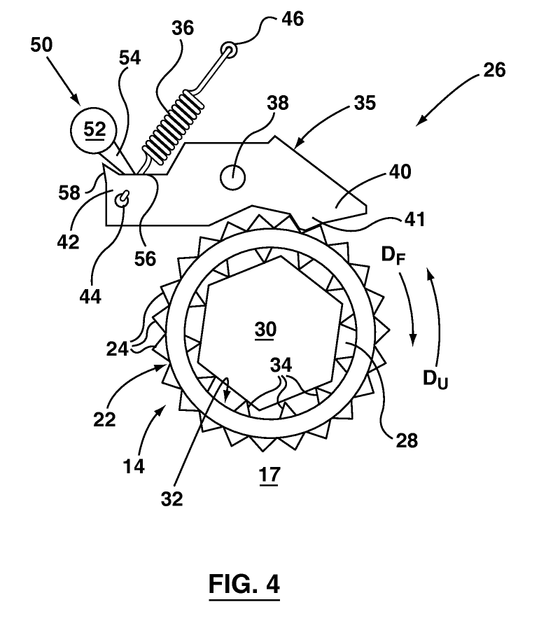

Referring now to FIGS. 3 and 4, the receivers 14 each have an aperture 28 defined therein to non-rotatably receive at least a portion of a rotary fastener, such as bolt head 30. (It is to be understood that a rotary fastener may also be, without limitation, a nut.) In the illustrated embodiment, each receiver 14 has a toothed inner peripheral rim 32 comprising a plurality of teeth 34. As can be seen, the teeth 34 cooperate with the bolt head 30 so as to prevent the bolt head 30 from rotating within the aperture 28, and in a preferred embodiment, the teeth 34 are arranged so that the bolt head 30 (or other rotary fastener) can be non-rotatably received in a variety of rotational positions relative to the respective receiver 14. Alternatively (not shown), the inner periphery of the receiver 14 can have a shape complementary to that of the bolt head 30, i.e. the aperture 28 can be hexagonal in shape so as to non-rotatably receive the bolt head 30 (or a hexagonally-shaped nut).

As noted above, the device 10 further comprises a rotation control mechanism, which is operable to inhibit rotation of the receivers in an unfastening direction and permit rotation of the receivers in a fastening direction, as will be described in greater detail below. Continuing to refer to FIGS. 3 and 4, in a non-limiting, exemplary embodiment, the rotation control mechanism comprises a plurality of individual ratchet arrangements 26 that are used to permit rotation of the receivers 14 in a fastening direction, and resist rotation of the receivers 14 in the unfastening direction. As noted above, each receiver 14 has a toothed outer peripheral rim 22 comprising a plurality of teeth 24, and the ratchet arrangement comprises a pawl 35 adapted to engage the toothed outer peripheral rim 22 and a biasing member 36 (a spring 36 in the embodiment shown in FIG. 3) operable to bias the pawl 35 into engagement with the toothed outer peripheral rim 22 so that rotation of the receivers in an unfastening direction is resisted and rotation of the receivers in a fastening direction is permitted.

With reference now to FIG. 4, it can be seen that the-pawl 35 is pivotally mounted to the housing 12, and in particular to the inner plate 17, by a pivot pin 38. The pawl 35 has a head 40 that has a projection 41 shaped to fit between the teeth 24 on the outer peripheral rim 22, and a foot 42, with the pivot pin 38 being positioned between the head 40 and the foot 42 of the pawl 35. The biasing member 36 is secured to the pawl 35 at a point 44 near the foot 42 of the pawl 35, and to the inner plate 17 at a suitable position 46 (for example by hooking the ends of the biasing member 36 through respective apertures as shown or by securing the end of the biasing member 36 about a post) so as to bias the pawl 35 to pivot so that its head 40, and in particular the projection 41, engages with the toothed outer peripheral rim 22. As can be seen in FIG. 4, the head 40 of the pawl 35 is shaped, and the pawl 35, pivot pin 38, biasing member 36 and attachment points 44 and 46 are configured to permit rotation in the fastening direction (indicated by the arrow D_{F}) and resist rotation in the unfastening direction (indicated by the arrow D_{U}). More particularly, the arrangement is such that when force in the fastening direction D_{F} is exerted on the receiver 14, the force exerted by the tooth 24 against the projection 41 on the head 40 of the pawl 35 causes the pawl 35 to pivot away from the receiver 14 so that the tooth 24 can move past the projection 41 and head 40, but when force in the unfastening direction Du is exerted on the receiver 14, the force exerted by the tooth 24 against the projection 41 on the head 40 of the pawl 35 causes the pawl 35 to pivot further toward the receiver 14, thereby maintaining the pawl 35 in position and resisting rotation of the receiver 14 in the unfastening direction D_{U}.

Referring briefly to FIGS. 1 and 3, a plurality of disengagement actuators 50 may optionally be provided, with each disengagement actuator 50 corresponding to one of the ratchet arrangements 26. Each disengagement actuator 50 is selectively operable to move its respective pawl 35 out of engagement with the toothed outer peripheral rim 22 of the respective receiver 14 to enable free rotation of the receiver 14 relative to the housing 12.

Referring again to FIG. 4, each disengagement actuator 50 comprises an actuator shaft 52 and a cam lever 54 extending from the actuator shaft 52 toward the foot 42 of the respective pawl 35. The actuator shaft 52 is rotatably received in the inner face 17 of the housing 12, and extends through the outer face 16 of the housing 12 (not shown in FIG. 4, see FIG. 2) so that a user can grasp and rotate the actuator shaft 52, using fingers or a tool (e.g. pliers). As can be seen in FIG. 4, rotating the actuator shaft 52 toward the pawl 35 causes the cam lever 54 to bear against a cam surface 56 on the foot 42 of the pawl 35, applying a force to overcome that exerted by the biasing member 36 and pivoting the pawl 35 so that its head 40 moves away from the receiver 14, moving the projection 41 out of engagement with the teeth 24 on the toothed outer peripheral rim 22, thereby enabling the receiver 14 to rotate freely relative to the housing 12. When the rotational force on the actuator shaft 52 is released, the biasing member 36 pivots the pawl 35 back into engagement with the toothed outer peripheral rim 22. A stop 58 is provided at the foot 42 of the pawl 35 adjacent the cam surface 56 to inhibit overtravel of the cam lever 54; if such overtravel should occur, the cam lever 54 can be brought back into engagement with the cam surface simply by continuing to rotate the actuator shaft 52. The ability to manually disengage the pawl 35 may be advantageous, for example, in dealing with situations in which a rotary fastener, such as bolt head 30, is binding with the toothed inner peripheral rim 32.

It is to be appreciated that the ratchet arrangement 26 described above is exemplary only, and that any suitable ratchet arrangement or similar mechanical contrivance may equivalently be used so long as it is capable of resisting the forces encountered by the relevant vehicle wheel during travel.

Other embodiments of a device according to aspects of the present invention are also contemplated. In one such contemplated embodiment, a device for resisting rotation of rotary fasteners comprises a housing that is removably securable over a vehicle wheel and a plurality of receivers arranged in the housing so as to be complementary to positions of rotary fasteners on the vehicle wheel to which the device is to be mounted, in which each receiver has associated therewith a locking mechanism that can be moved between a first configuration in which rotation of the receiver relative to the housing is resisted, and a second configuration in which rotation of the receivers relative to the housing is permitted, and can be secured in at least the first configuration. Thus, when each locking mechanism in the device is in the first, resisting configuration, the receivers would be inhibited from rotating in either the fastening or the unfastening direction, and when a particular locking mechanism in the device is in the second, non-resisting configuration, the respective receiver would be permitted to rotate in either the fastening or the unfastening direction. Placing the locking mechanisms in the second, non-resisting configuration during installation of the housing over the vehicle wheel would enable the receivers to be freely rotated to facilitate insertion of the relevant portion of the rotary fasteners into the receivers. Then, once the housing has been secured in position, placing the locking mechanisms in the resisting configuration will inhibit the rotary fasteners from rotating in either the fastening or unfastening direction. Accordingly, while vibration of the vehicle wheel during travel would not further tighten the rotary fasteners (because rotation of the receivers in either direction is resisted), such vibration would also be inhibited from causing the rotary fasteners to loosen or become unfastened (again because rotation of the receivers is resisted). Because of vibration associated with travel of the vehicle, it is desirable to secure the locking mechanisms in the first configuration so that such vibration does not cause the device to be moved into the second configuration during travel of the vehicle. Any mechanical arrangement or contrivance that is operable to enable the device to be selectively moved between a first configuration in which rotation of the receivers is resisted, and a second configuration in which rotation of the receivers is permitted, and secured in at least the first configuration, may equivalently be used, and the particular exemplary embodiments described herein are not intended to be limiting in any way.

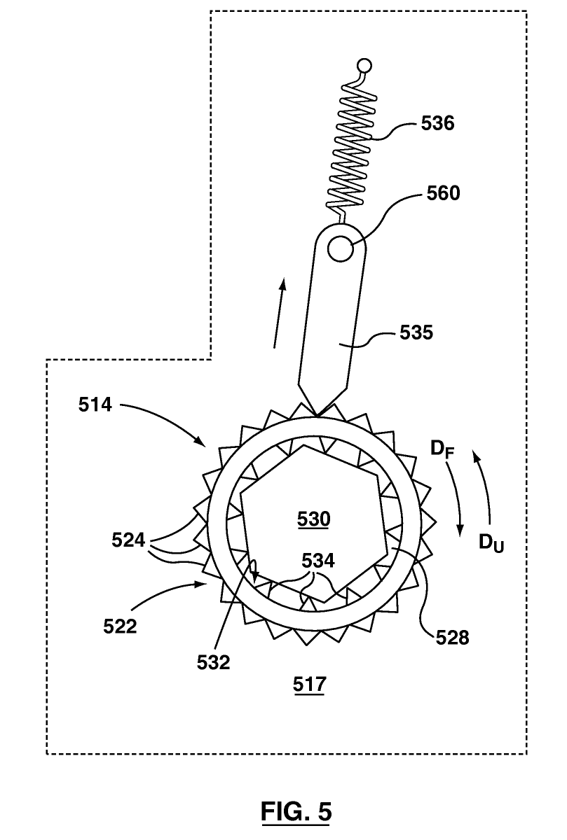

With reference now to FIG. 5, a non-limiting, exemplary implementation of a portion of a device for resisting rotation of rotary fasteners, which can be selectively moved between a first configuration in which rotation of the receivers is resisted, and a second configuration in which rotation of the receivers is permitted, and secured in at least the first configuration, is shown. The device includes a housing in which a plurality of receivers 514 are rotatably mounted in a manner analogous to that described above in respect of the housing 12 and receivers 14, with the receivers 514 arranged in the housing so as to be complementary to positions of rotary fasteners on the vehicle wheel over which the housing is to be removably secured.

Each receiver 514 has a toothed outer peripheral rim 522 comprising a plurality of teeth 524, and an aperture 528 defined therein to non-rotatably receive at least a portion of a rotary fastener, such as bolt head 530. (It is to be understood that a rotary fastener may also be, without limitation, a nut.) Like the receivers 14 described above, each receiver 514 has a toothed inner peripheral rim 532 comprising a plurality of teeth 534. As can be seen, the teeth 534 cooperate with the bolt head 530 so as to prevent the bolt head 30 from rotating within the aperture 528. Alternatively (not shown), the inner periphery of the receiver 514 can have a shape complementary to that of the bolt head 530, i.e. the aperture 528 can be hexagonal in shape so as to non-rotatably receive the bolt head 530 (or a nut).

Each locking mechanism comprises a pawl 535 that is slidably mounted to an inner plate 517 so as to be movable into and out of engagement with the toothed outer peripheral rim 522. The pawl 535 is biased into engagement with the toothed outer peripheral rim 522 by a biasing member 536 secured at one end to the inner plate 517 and at the other end to the pawl 535. When the pawl 535 engages the toothed outer peripheral rim 522 as shown in FIG. 5 (the first, resisting configuration), the receiver 514 is inhibited from rotating in either the fastening direction D_{F} or the unfastening direction Du, and when the pawl 535 does not engage the toothed outer peripheral rim 522 (the second, non-resisting configuration), the receiver 514 can rotate freely in either the fastening direction DF or the unfastening direction Du. The pawl 535 maybe selectively secured in at least the first, resisting configuration, so as to maintain the pawl 535 in the first configuration during travel of a vehicle, and may optionally also be selectively secured in the second, non-resisting configuration. Such securing may be achieved by any suitable mechanical technique. Optionally, where the biasing member 536 is sufficiently strong, such securing maybe effected by the force exerted by the biasing member 536 itself.

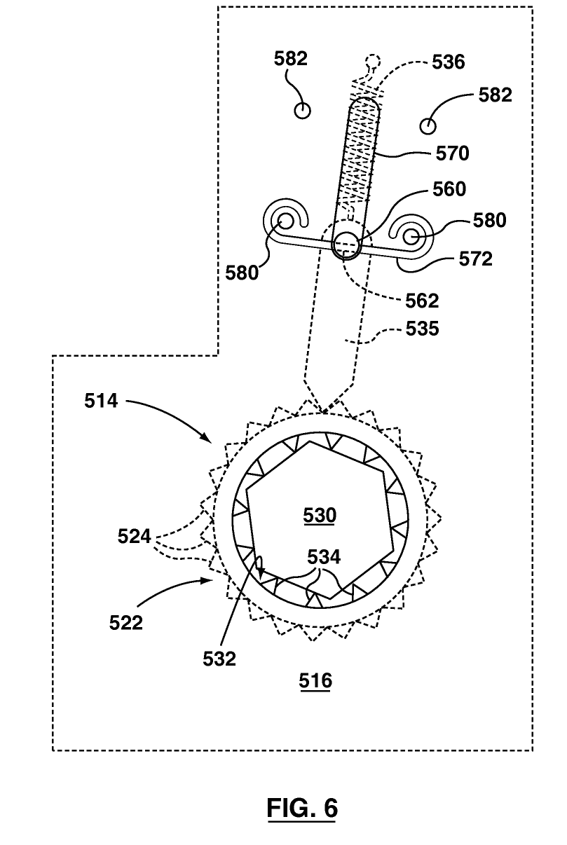

In other embodiments, additional or alternative securing techniques may be used. For example, as shown in FIGS. 5 and 6, the pawl may include a post 560 which projects through a slot 570 in an outer plate 516, so that a user may grip the post 560 to move the pawl 535 between the first, resisting configuration and the second, non-resisting configuration. The post 560 may have a cross-bore 562 defined therethrough, in the portion disposed outside the outer plate 516, for removably receiving a pin 572. The pin 572 cooperates with outwardly projecting stops 580, 582 positioned on either side of the slot 570 adjacent the ends thereof to maintain the pawl in either the first, resisting configuration (stops 580) and the second, non-resisting configuration (stops 582). The pin 572 maybe bent once installed, so as to assist in maintaining it in position, as shown in FIG. 6.

Optionally a mechanism maybe provided for simultaneously moving all of the pawls 535 between the first, resisting configuration and the second, non-resisting configuration. For example, where the posts 560 define a circle, a suitably sized spacer having a frusto-conical tip maybe used, with the frusto-conical portion having a first, insertion end whose circumference is equal to the circumference of the circle formed by the posts 560 when in the first, resisting configuration, and having a second end(which maybe an intermediate point of the spacer) whose circumference is equal to the circumference of the circle formed by the posts 560 when in the second, non-resisting configuration. Such a spacer may be slid into the circle formed by the posts 560 when in the first, resisting configuration, thereby pushing each post 560 outwardly into the second, non-resisting configuration and moving the pawls 535 out of engagement with the toothed outer peripheral rim 522 to enable installation of the device over a vehicle wheel.

Embodiments of devices according to the present invention may advantageously be employed in methods for securing vehicle wheels.

in one embodiment, such a method could include the step of securing a device over a vehicle wheel, wherein the device comprises a housing that is removably securable over an exterior face of a vehicle wheel and a plurality of receivers arranged in the housing so as to be complementary to positions of rotary fasteners on the vehicle wheel over which the device is to be mounted, the receivers each having an aperture defined therein to non-rotatably receive at least a portion of a rotary fastener, the receivers each being rotatable relative to the housing and wherein rotation of the receivers in an unfastening direction is resisted and rotation of the receivers in a fastening direction is permitted. The aforesaid method may further include steps of, after securing the device to a vehicle wheel, causing the vehicle to travel to a selected destination, removing the device and optionally inspecting the rotary fasteners on the vehicle wheel.

In another embodiment, such a method could include the step of securing a device over a vehicle wheel, wherein the device comprises a housing that is removably securable over a vehicle wheel and a plurality of receivers arranged in the housing so as to be complementary to positions of rotary fasteners on the vehicle wheel to which the device is to be secured, the receivers each having an aperture defined therein to non-rotatably receive at least a portion of a rotary fastener and each being rotatable relative to the housing, and wherein each receiver has associated therewith a locking mechanism selectively movable between a first configuration in which rotation of the receivers is resisted, and a second configuration in which rotation of the receivers is permitted, and which can be maintained in the first configuration. The steps of such a method could include placing each locking mechanism in the second configuration, securing the device over a vehicle wheel, placing the locking mechanisms into the first configuration and securing the locking mechanisms in the first configuration, causing the vehicle to travel to a selected destination, removing the device and optionally inspecting the rotary fasteners on the vehicle wheel. Optionally, the locking mechanisms maybe placed in the second configuration before the device is removed.

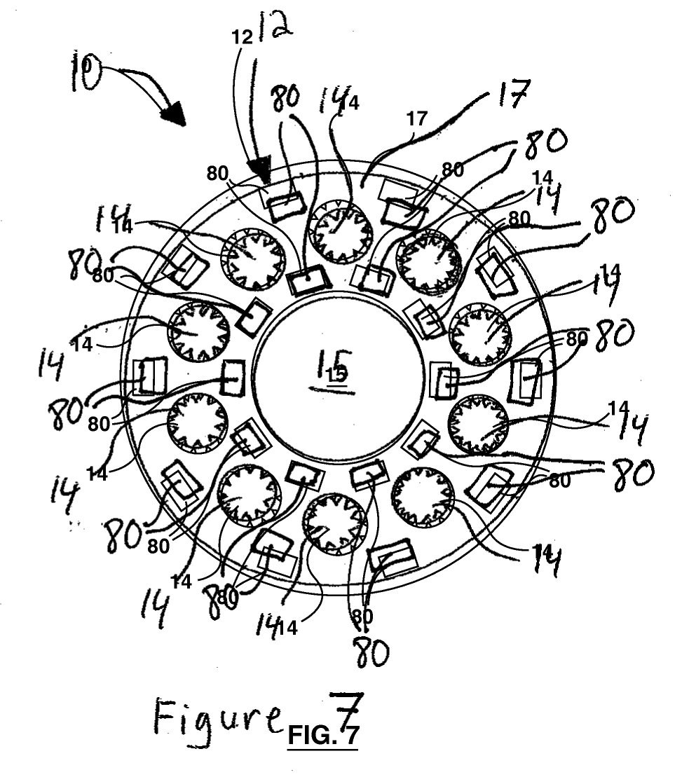

As noted above, devices according to aspects of the present invention maybe secured over vehicle wheels by a variety of techniques. As shown in FIG. 7, where the vehicle wheel is constructed from suitable material, such as steel, a device according to an aspect of the present invention, such as the device 10, maybe provided with magnets 80 of suitable strength secured to, or embedded in, the inner plate 17 to retain the device on the face of the vehicle wheel during travel of the vehicle.

Where the rotary fasteners to be secured are nuts, securing of devices according to aspects of the present invention over a vehicle wheel maybe achieved by having the bolts which receive the nuts be of sufficient length to receive a second nut, disposed exteriorly of the first nut and having a larger outer diameter than the first nut.

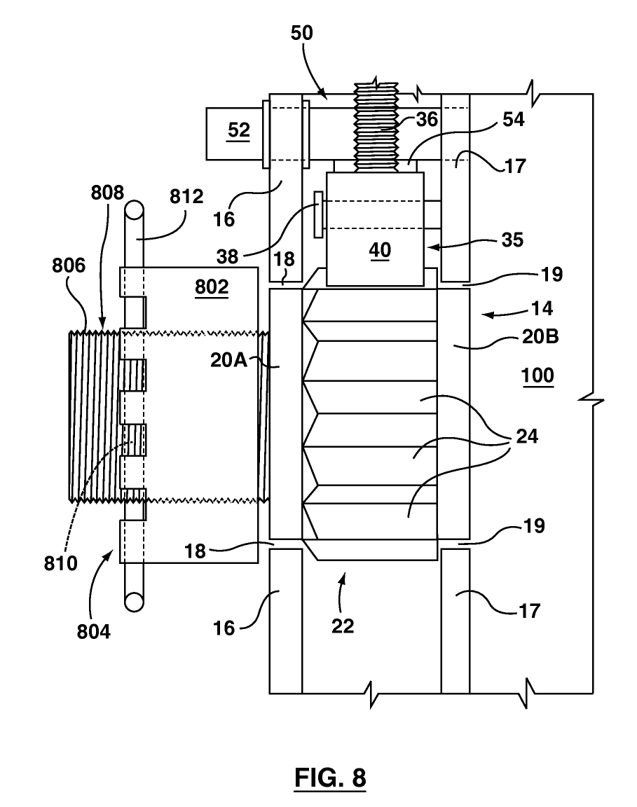

In one such embodiment, as shown in FIG. 8, the second nut is a crown nut 802, whose crown 804 faces outwardly. In this embodiment, the shaft 806 of the bolt 808 has a cross-bore 810 defined therethrough which receives a pin 812, which is bent to be retained in the cross-bore 810, which inhibits the crown nut 802 from unfastening during vibration.

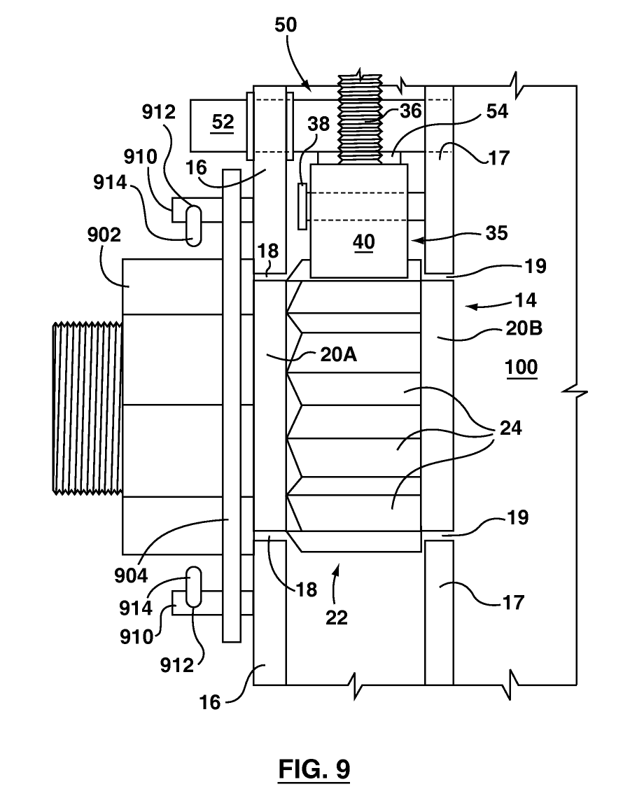

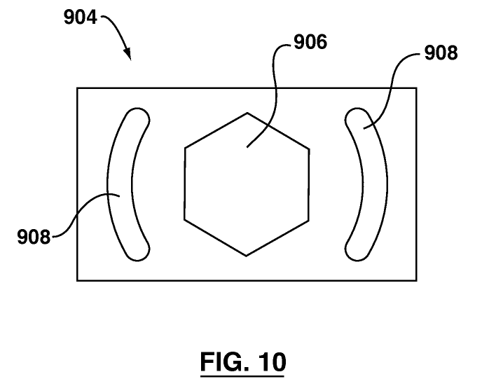

In another embodiment, as shown in FIGS. 9 and 10, the second nut may be a standard nut 902 which may be inhibited from unfastening by a securing panel 904 which has an aperture 906 (see FIG. 10) corresponding in shape to the nut 902 to non-rotatingly receive the nut 902. The securing panel 904 also includes two opposed arcuate slots 908 (see FIG. 10) positioned on either side of the aperture 906. The arcuate slots 908 receive correspondingly positioned short posts 910 extending outwardly from the outer plate 16, with each post 910 having a cross-bore 912 defined therein for receiving a pin 914, which holds the securing panel in position. The arcuate slots 908 provide sufficient “play” for the aperture 906 to be aligned with the nut 902 while still limiting rotation of the nut 902 and securing panel 904 so as to inhibit unfastening of the nut 902.

Optionally (not shown), the housing 12 may be rotatably mounted to an arm that can be releasably secured to the body of the vehicle with which the device 10 is to be used, so that the arm maintains the position of the device 10 relative to the vehicle wheel while allowing the device 10 to freely rotate with the vehicle wheel.

It is to be understood that the present invention is not limited to the particular embodiments shown and described herein, and is intended to encompass any arrangement in which a plurality of receivers are secured within a housing adapted to be secured over a vehicle wheel with rotary fasteners on the vehicle wheel being non-rotatably received by the receivers, wherein the receivers can be rotated relative to the housing in at least one direction during installation of the housing, and can be inhibited from rotating in the unfastening direction once installed.

One or more currently preferred embodiments have been described byway of example. It will be apparent to persons skilled in the art that a number of variations and modifications can be made without departing from the scope of the invention. Any mechanical arrangement or contrivance that is operable to permit rotation of receivers (e.g. the receivers 14) in the fastening direction and resist rotation of the receivers in the unfastening direction may equivalently be used, and the particular exemplary embodiments described herein (including the toothed outer peripheral rims 22, 522 described below) are not intended to be limiting in any way.

What is claimed is:

1. A device for inhibiting rotation of rotary fasteners, comprising:
a housing, the housing being removably securable over an exterior face of a vehicle wheel;
a plurality of receivers arranged in the housing so as to be complementary to positions of rotary fasteners on the vehicle wheel over which the device is to be mounted, the receivers each having an aperture defined therein to non-rotatably receive at least a portion of a rotary fastener, the receivers each being rotatable relative to the housing; and
a rotation control mechanism disposed within the housing operable to inhibit rotation of the receivers in an unfastening direction and permit rotation of the receivers in a fastening direction, the unfastening direction and the fastening direction each being relative to the rotary fasteners.

2. The device of claim 1, wherein each receiver has a toothed inner peripheral rim.

3. The device of claim 1, wherein:
each receiver has a toothed outer peripheral rim, and
the rotation control mechanism comprises a plurality of individual ratchet arrangements, each ratchet arrangement comprising:
a pawl movably mounted to the housing and positioned to engage the toothed outer peripheral rim of a respective receiver; and
a biasing member secured to the housing and to the pawl to bias the pawl into engagement with the toothed outer peripheral rim;
so that rotation of the respective receiver in an unfastening direction is resisted by engagement of teeth on the toothed outer peripheral rim with the pawl, and rotation of the receivers in a fastening direction is permitted.

4. The device of claim 3, wherein each pawl is pivotally mounted to the housing.

5. The device of claim 4, wherein the rotation control mechanism further comprises a plurality of disengagement actuators mounted in the housing, each disengagement actuator corresponding to one of the ratchet arrangements, each disengagement actuator being selectively operable to move its respective pawl out of engagement with the outer toothed peripheral rim of the respective receiver to enable free rotation of the receiver relative to the housing in both the fastening and the unfastening direction.

6. The device of claim 5, wherein each disengagement actuator comprises:
an actuator shaft rotatably received in an inner face of the housing and extending through an outer face of the housing;
the actuator shaft having a cam lever extending therefrom toward a foot of the respective pawl;
so that rotating the actuator shaft toward the pawl causes the cam lever to bear against a cam surface on the foot of the pawl and pivot the pawl out of engagement with the teeth on the toothed outer peripheral rim of the respective receiver, enabling the receiver to rotate freely relative to the housing.
